(19) United States
(12) Patent Application Publication
(10) Pub. No.: US 2015/0134394 A1
(43) Pub. Date: May 14, 2015

(54) SYSTEM FOR PLANNING A BUILDING PROJECT

(71) Applicant: Mark S. Sands, Belmont, MI (US)

(72) Inventor: Mark S. Sands, Belmont, MI (US)

(21) Appl. No.: 14/080,159

(22) Filed: Nov. 14, 2013

(51) Int. Cl. G06Q 10/06; G06Q 50/16

(52) U.S. Cl. CPC G06Q 10/06313; G06Q 50/16
USPC 705/7.23

(57) ABSTRACT

A computer-implemented system produces a digital representation of a space program, scope of major systems, and construction cost based on functions of the space program, for a proposed building the system. The system includes databases containing stored data, a computer program, connected to the databases, and input data. The computer program is configured to calculate a statistical model of parametric data for the proposed building based on the input data and the databases and to automatically generate building outcomes based on the statistical model.

### BACKGROUND OF THE INVENTION

### Field of the Invention

The present invention relates generally to an automated system for planning a building project, and, more particularly, to a global database and a computer software program that enables accurate cost prediction early in a building planning process.

### BACKGROUND OF THE INVENTION

Planning, designing, and managing building projects, and particularly commercial buildings, typically requires enormous effort and resources to compile, manipulate, sort, and evaluate large quantities of data, much of which changes regularly, from across many disciplines, and from many different and disparate sources. This data can include, for example, land and building costs; building size, type, and configuration; architectural and engineering solutions; and financing options.

Some automation of some of the components involved in building planning and design is known. For example, software is available to enable contractors to provide job cost estimates. Planners use spreadsheets to tabulate data and generate reports based on the collected data. Graphics software (e.g. CADD) is enabled to provide some design features of buildings, generating such things as space configurations, and building appearance.

U.S. Pat. No. 6,859,768 discloses an automated building design and modeling project cost estimation and scheduling system (referred to therein as a “DEMS” system). The disclosed DMES system uses object based computer-implemented code and databases to develop design and construction document information needed to complete a building project. The DMES system is form-based in that it is dependent on parametric data entered by a user in the time period that a building is being designed.

But planning of a building project typically occurs far in advance of a building design. FIG. 1 depicts costs and decision impact plotted against a typical timeline of a building project. One can see that the timeline of a building project comprises the activities of planning 10, programming 12, design 14, procurement 16, and construction 18 that occur sequentially. Costs incurred in the building project generally track curve A, where costs are least toward the beginning and most toward the end. Conversely, the impact of decisions made during each of the activities generally track curve B where the impact of decisions made at the planning stage are greater than decisions made at the construction stage. Current planning systems such as the form-based DMES disclosed in U.S. Pat. No. 6,859,768 typically occur after planning and programming, i.e., at or around the design phase. In other words, decisions are typically based on build costs because there are too many disparate resources and, consequently, too much cost involved to accurately project operating expenses and render realistic comparisons for different planning hypotheticals before then. But the window C between cost and impact at the design phase narrows quickly, meaning that the opportunity for low-cost change in planning and programming may be lost by that time. There remains a need to integrate the disparate sources and volumes of data necessary to fully plan and/or design a building at an earlier phase than building design. Great savings in time, effort, and cost can be realized by an effectively integrated system at an earlier time than the present state of the art permits.

### SUMMARY OF THE INVENTION

A computer-implemented system is described for producing, for a proposed building, a digital representation of a space program, scope of major systems, and construction cost based on functions of the space program. The system includes databases containing stored data about program area, building systems parametrics, and costs associated with occupancies and purposes of buildings compiled from disparate sources. A computer program, stored and operable in one or more servers, is connected to the databases, and accessible via a global network. The system also includes input data comprising values of functional, physical and performance variables associated with the proposed building. The computer program is configured to calculate a statistical model of parametric data for the proposed building based on the input data and the databases and to automatically generate building outcomes based on the statistical model.

### BRIEF DESCRIPTION OF THE DRAWINGS

FIG. 1 is a graph depicting cost and impact over time in a building project.

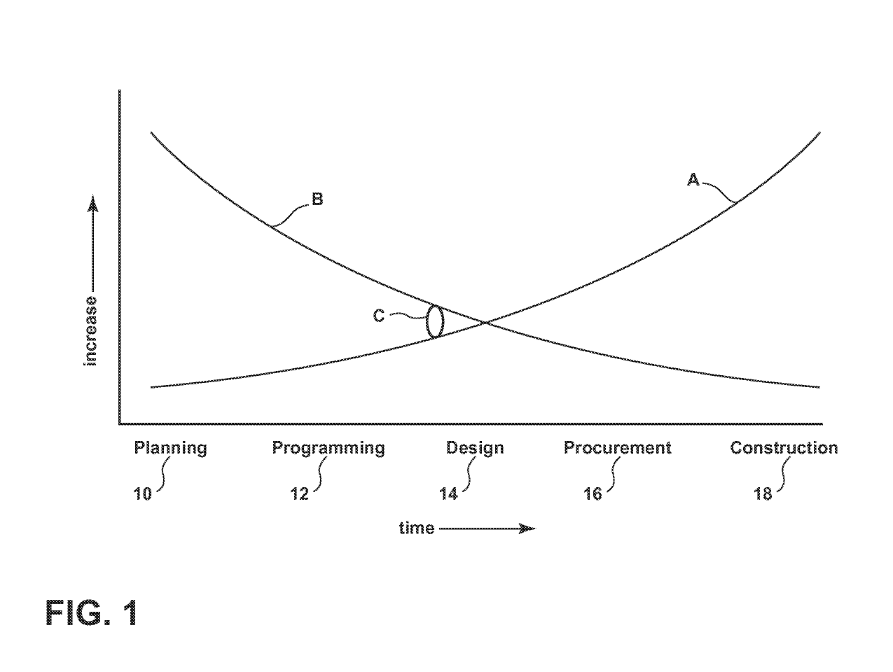

FIG. 2 is a schematic diagram of an embodiment of a computer implemented system according to the present invention.

FIG. 3 is a flowchart showing an operation of the computer implemented system of FIG. 2.

FIG. 4 is an exemplary first data entry page of the computer implemented system of FIG. 2 for receiving input data, in accordance with the present invention.

FIG. 5 is an exemplary second data entry page of the computer implemented system of FIG. 2 for filtering the input data of FIG. 4.

FIG. 6 is a table of exemplary stored data about costs associated with parameters of building construction in a database of the computer implemented system of FIG. 2.

FIG. 7 is a portion of a program cost and data report as output data generated by the computer implemented system of FIG. 2.

FIG. 8 is an example of output data acted upon by conducting a “what if” operation in a computer implemented system according to the invention.

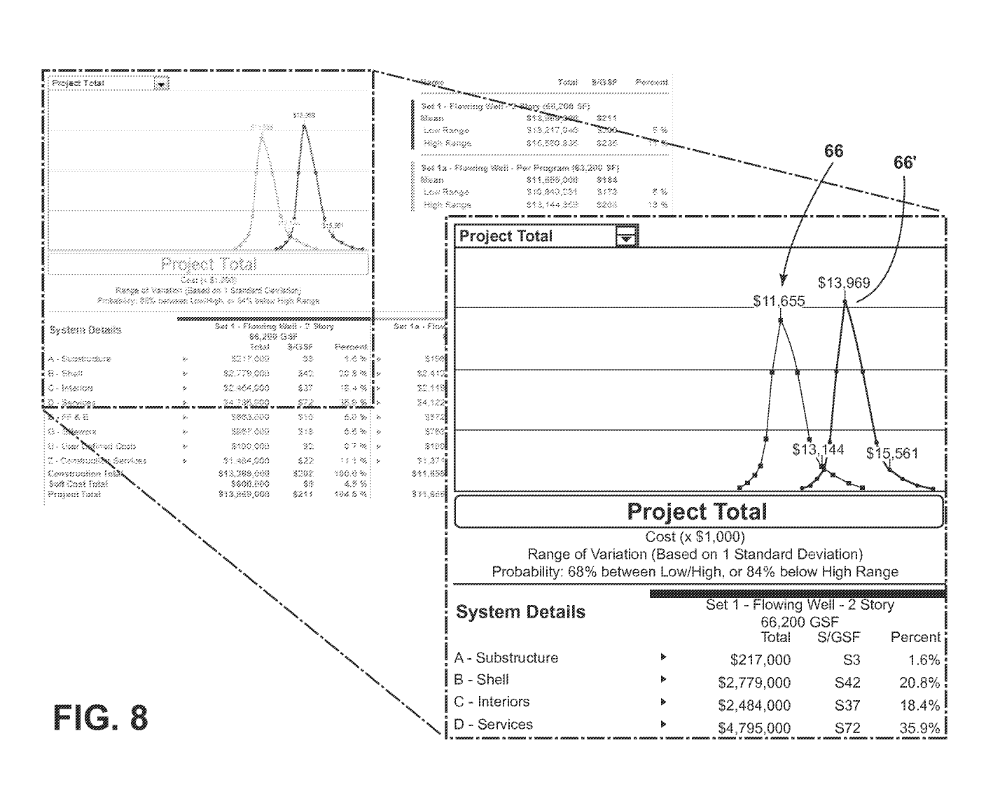

### DETAILED DESCRIPTION

In the background and the following description, for the purposes of explanation, numerous specific details are set forth in order to provide a thorough understanding of the technology described herein. It will be evident to one skilled in the art, however, that the exemplary embodiments may be practiced without these specific details. In other instances, structures and devices are shown in diagram form in order to facilitate description of the exemplary embodiments.

The exemplary embodiments are described with reference to the drawings. These drawings illustrate certain details of specific embodiments that implement a module, method, or computer program product described herein. However, the drawings should not be construed as imposing any limitations that may be present in the drawings. The method and computer program product may be provided on any machine-readable media for accomplishing their operations. The embodiments may be implemented using an existing computer processor, or by a special purpose computer processor incorporated for this or another purpose, or by a hardwired system.

As noted above, embodiments described herein may include a computer program product comprising machine-readable media for carrying or having machine-executable instructions or data structures stored thereon. Such machine-readable media can be any available media, which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium that can be used to carry or store desired program code in the form of machine-executable instructions or data structures and that can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data, which cause a general purpose computer, special purpose computer, or special purpose processing machines to perform a certain function or group of functions.

Embodiments will be described in the general context of method steps that may be implemented in one embodiment by a program product including machine-executable instructions, such as program codes, for example, in the form of program modules executed by machines in networked environments. Generally, program modules include routines, programs, objects, components, data structures, etc. that have the technical effect of performing particular tasks or implement particular abstract data types. Machine-executable instructions, associated data structures, and program modules represent examples of program codes for executing steps of the method disclosed herein. The particular sequence of such executable instructions or associated data structures represent examples of corresponding acts for implementing the functions described in such steps.

Embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the internet and may use a wide variety of different communication protocols. Those skilled in the art will appreciate that such network computing environments will typically encompass many types of computer system configurations, including personal computers, hand-held devices, multiprocessor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination of hardwired or wireless links) through a communication network. In a distributed computing environment, program modules may be located in both local and remote memory storage devices.

An exemplary system for implementing the overall or portions of the exemplary embodiments might include a general purpose computing device in the form of a computer, including a processing unit, a system memory, and a system bus, that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

Technical effects of the system and method disclosed herein include generation of early, accurate, and reliable cost data related to the planning of building programs before actually designing a building. Consequently, planning and development processes that typically occur in building programs can be accomplished more efficiently with lower costs and greater impact than heretofore possible.

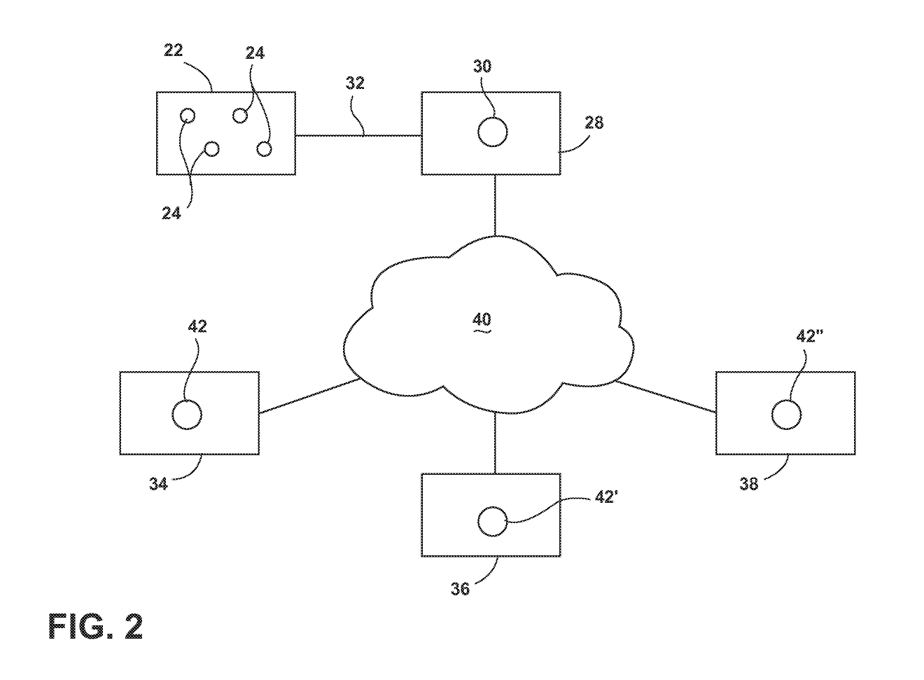

An overview of a computer implemented system 20 according to the present invention is shown in FIG. 2. The system 20 comprises one or more memory locations 22 containing databases 24 with stored data 26. Connected to the memory location 22 is at least one server 28 in which a computer program 30 is stored and operable. The computer program 30 is connected to the databases at 32 (wirelessly or by bus), and is accessible from multiple remote locations 34, 36, 38, preferably via a global network 40 such as the internet. Users at such remote locations can generate input data 42 42′, 42″ that includes values of functional, physical and performance variables associated with a proposed building. The computer program 30 is configured to calculate a statistical model of parametric data for the proposed building based on the input data 42, 42′, 42″and the databases 24 and to automatically generate building outcomes based on the statistical model.

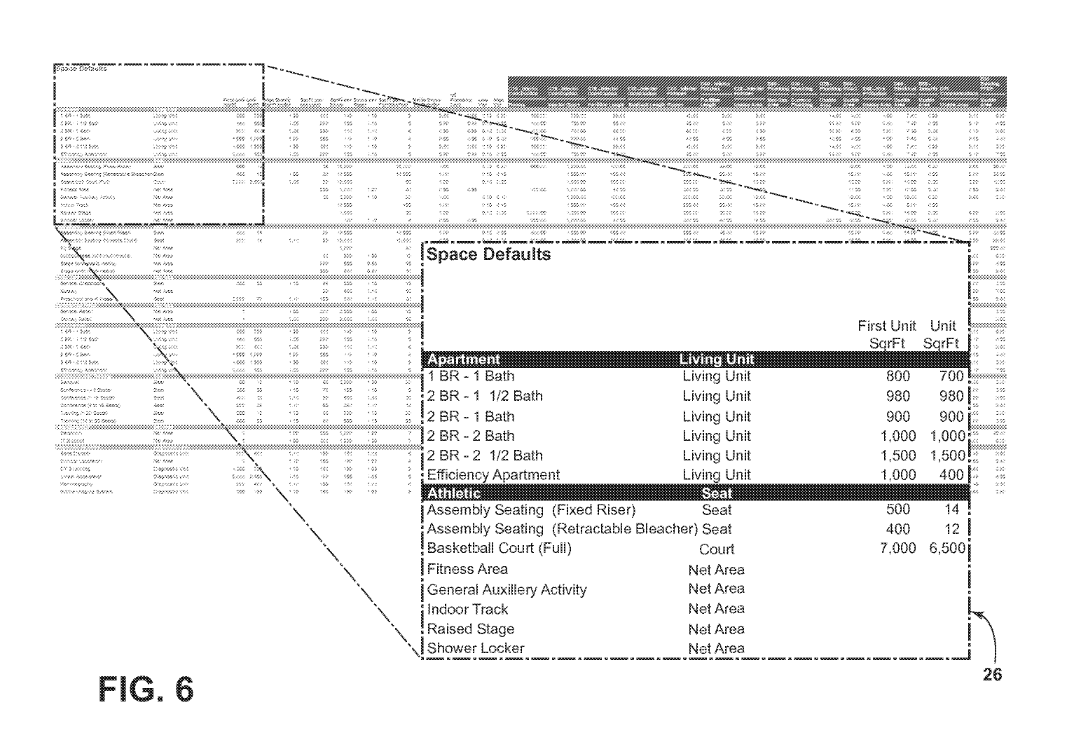

Looking now at FIG. 6, stored data 26 in the databases 24 includes data about program area, building systems parametrics, and costs associated with occupancies and purposes of buildings compiled from disparate sources. Program area relates to spaces within buildings. Building systems parametrics relate to major systems that operate within buildings, such as mechanicals, elevators, and the like. Such data is “real world” in that it is as current as practicable, and is specific to predetermined geographic locations and types of buildings. For example, the stored data may include typical program areas, systems parametrics, and construction costs for hospitals in Las Vegas, Nevada. Stored data 26 may also include cost-escalating factors, local building attributes, city cost index data, local construction costs, and performance standards.

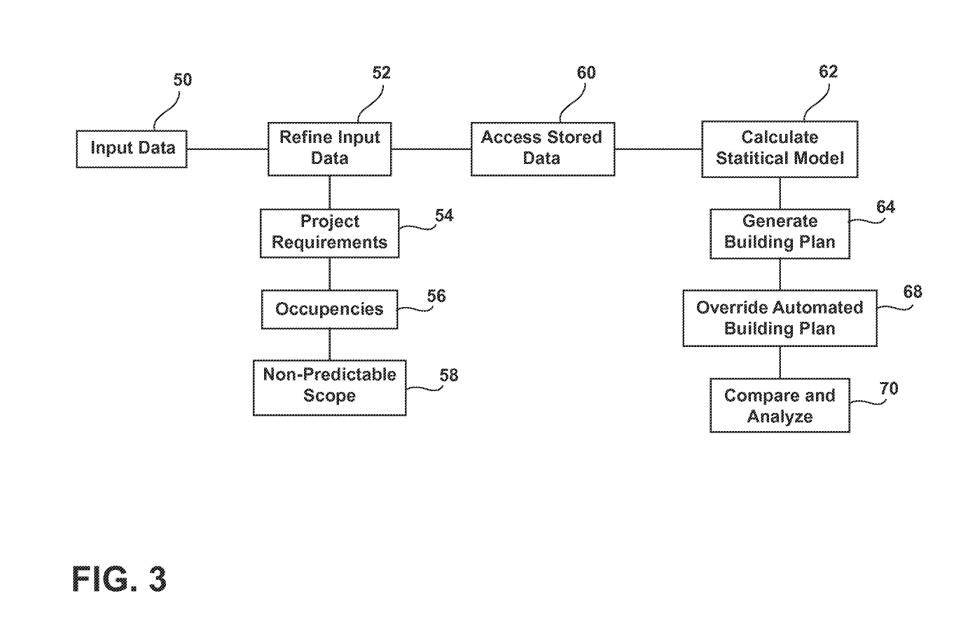

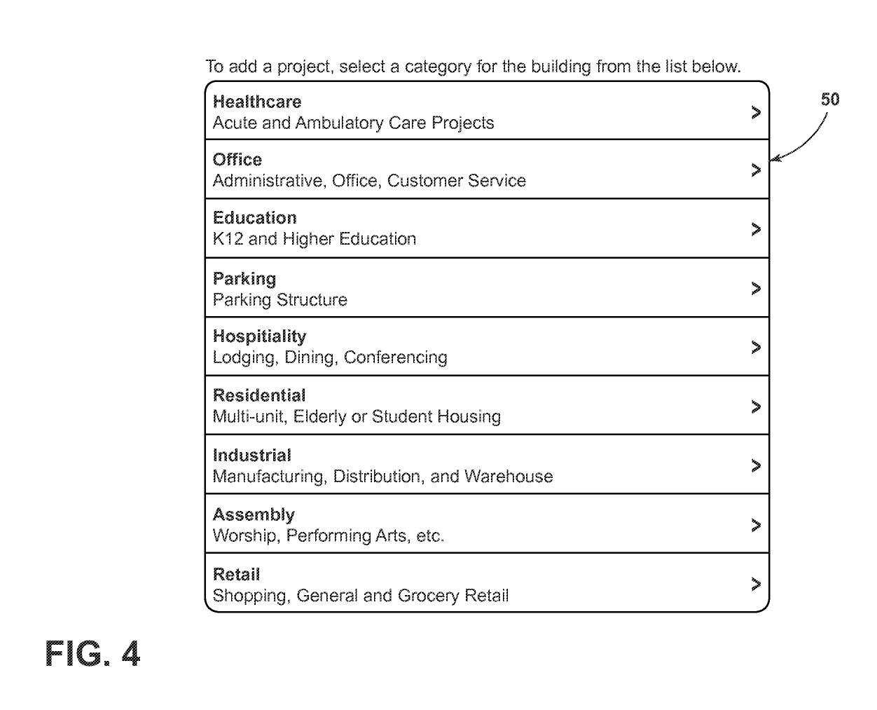

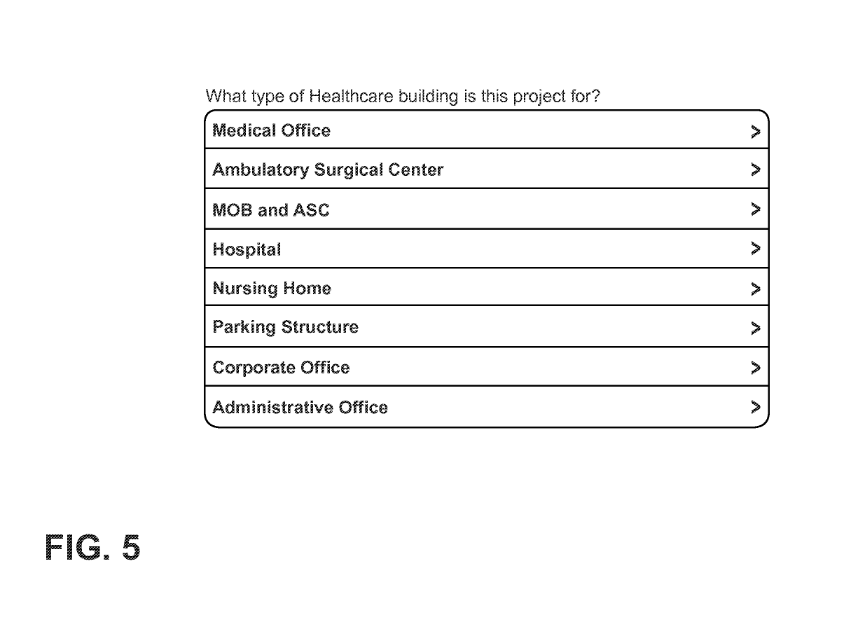

An embodiment of a method of using the system 20 is shown schematically in the flow chart of FIG. 3. In a first step 50 input data 42 is created by a user, preferably at one of a plurality of remote locations 34, 36, 38 (see FIG. 2). Such input data 42 may include a category of the proposed building or facility (e.g., Healthcare). In FIG. 4, an exemplar of an input screen for a user shows various categories for a proposed building. Input data 50 may include filtering data. For example, a category of a proposed building may be filtered by specifying a type of building (e.g., Hospital). In FIG. 5, an exemplar of an input screen for a user shows various types of buildings within a selected category.

Input data 50 may also be refined at step 52 by entering a number of variables (called for example, Project Requirements 54) affecting the building outcomes, including: Location (region or metropolitan area), number of floors desired (including those below grade), location type (dense urban, urban, etc.), owner type (private, federal, etc.), construction type (new building, addition, etc.), quality classification, continuity of operations, security provisions, site difficulty, basis of design (energy/environmental standard), etc. Further, input data 50 may be refined at step 52 by defining occupancies 56 at each functional space designation (e.g., proposed department) by selecting space types and counts (e.g., 20 private beds under the acute patient care space category). The user may continue with all such types and counts within a department or space designation until finished to the user's satisfaction. The user may continue by adding other space designations in a similar way until all functional spaces are defined to the user's satisfaction. Input data 50 may be further refined at step 52 by defining any non-predictable scopes 58 of work to be included in the proposed building project (e.g., off site construction, environmental remediation, property costs, etc.). At any point in the input process, input data 50 may filtered as specific needs require. It is important to keep in mind that input data 50 includes values of functional, physical and performance variables associated with the proposed building, i.e., a user's choices of desired functional, physical and performance characteristics for the proposed building, not parametric data from which a design could be constructed.

At step 60, the databases 24 are accessed and stored data 26 is retrieved. The stored data 26 may be categorized by industry average (mode) and low/high range outcomes as follows: (1) Program Spaces: floor areas by space types, categories and designations (department), floor areas for supporting core and common spaces, (2) primary building quantities such as number of stairs, elevators; area of walls, glass, etc.; numbers of rooms, doors, etc. (3) Construction hard costs (substructure, shell, etc.), (4) Project development soft costs, (5) Energy consumption (heating, cooling, lighting, etc.), (6) Annual operating expenses (energy, service and maintenance, property taxes, cleaning, etc.) See FIG. 6 for example. The stored data 26 includes general parametric data such as program area, building systems parametrics, and costs of buildings, in contrast to the occupancies and purposes of buildings found in input data 50.

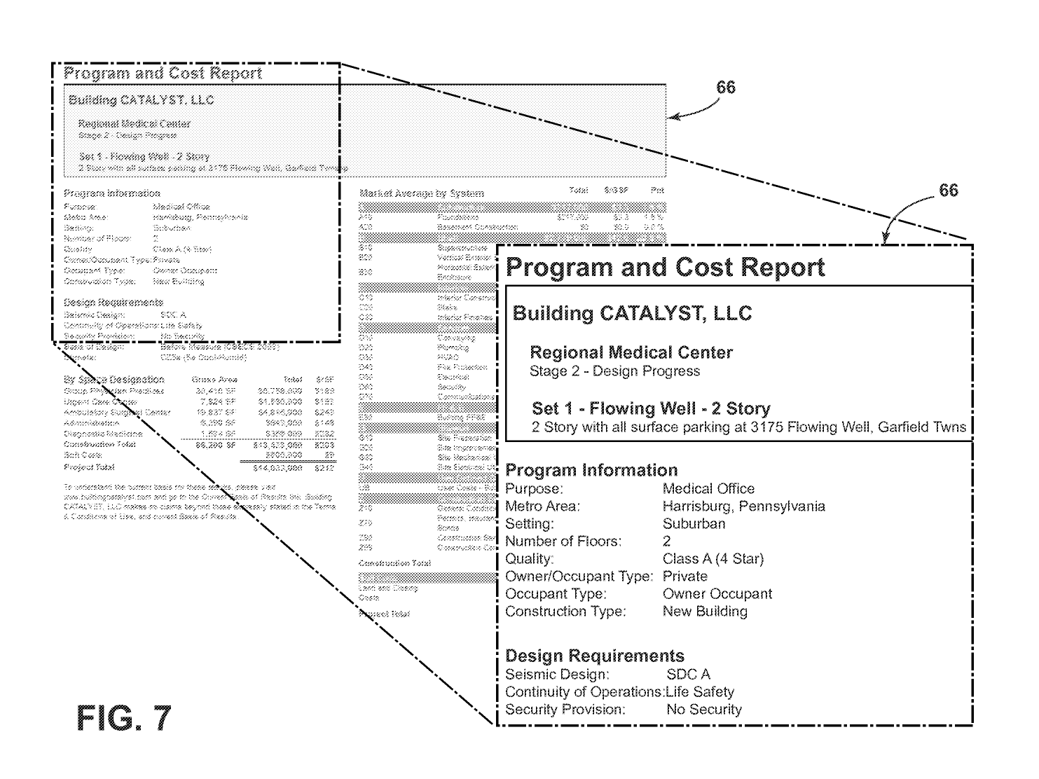

At step 62, the computer program 30 calculates a statistical model of parametric data for the proposed building based on the input data 50 and the stored data 26 retrieved from the databases 24. From the calculated statistical model, the computer program 30 then generates a building outcome at step 64. An exemplary building outcome 66 is shown FIG. 7, comprising a program and cost report, but the building outcome may include any type or portion of a building plan such as market data, constructions breakdowns and the like.

The building outcome 66 may be displayed to a user, whereupon the user may manually override any portion of the generated building outcome 66 at step 68. For example, the user may override the calculated floor areas based on other sources that are considered more accurate for the particular building at hand, and cause the computer program 30 to return to the statistical model to receive a revised and more precise building outcome 66. Similarly, a user may override the calculated building quantities based on other sources that are considered more accurate for the particular building at hand, and cause the computer program 30 to return to the statistical model to receive the revised and more precise outcomes 66. Similarly, a user may override the various costs or energy consumption outcome based on other sources that are considered more accurate, and cause the computer program 30 to return to the statistical model to receive the revised and more precise outcomes 66.

A user may create a new set of input data 50, such as new variables, occupancies, floor area, etc., or copy any of previously created sets of input data 50 and alter them to change one or more of the values, then cause the compute program 30 create a second statistical model and generate a second building outcome 66′. A user may create multiple building outcomes, from which the user can compare and analyze them at step 70.

It will be seen that given particular and several building functions (occupancy and purposes), as provided in the input data 42, a proposed building's space program can be predicted within a meaningful range of variation by the calculated statistical model. Further, given a space program and other attributes, the scope (key building system parametrics) can be similarly predicted. And, given the space program, plus scope plus other attributes, the cost of a project can be similarly predicted, all by the same statistical model. These predictions are made according to a standard provided in the stored data 26, and that standard is based on the actual results of completed real-world projects, be they across the marketplace, across a particular set of projects, or even a single project. In effect, a computer-implemented system according to the invention can predict the outcomes of a set of completed projects, and also be able to predict the outcomes of future projects, all within a meaningful range of variation provide by the calculated statistical model.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A computer-implemented system for producing, for a proposed building, a digital representation of a space program, scope of major systems, and construction cost based on functions of the space program, the system comprising:
databases containing stored data about program area, building systems parametrics, and costs associated with occupancies and purposes of buildings compiled from disparate sources;
a computer program, stored and operable in at least one server, connected to the databases, and accessible via a global network, and
input data comprising values of functional, physical and performance variables associated with the proposed building,
wherein the computer program is configured to calculate a statistical model of parametric data for the proposed building based on the input data and the databases and to automatically generate building outcomes based on the statistical model.

2. The computer-implemented system of claim 1 wherein the stored data comprises real world data specific to at least geographical locations and building type.

3. The computer-implemented system of claim 2 wherein the real world data is automatically periodically updated.

4. The computer-implemented system of claim 2 wherein the real world data can be manually overridden.

5. The computer-implemented system of claim 1 wherein the input data comprises at least one chosen from: building use, occupancy, and variables associated with building functionality, physical, and performance attributes.

6. The computer-implemented system of claim 5 wherein the input data is filtered.

7. The computer-implemented system of claim 1 wherein stored data comprises at least one chosen from: cost-escalating factors, local building attributes, city cost index data, local construction costs, and performance standards.

8. The computer-implemented system of claim 1 wherein the statistical model of parametric data comprises parameters of the proposed building including at least one of building area, systems scope, budget, construction schedule, building space utilization, land utilization, minimum land area required, and cost savings.

9. The computer-implemented system of claim 1 further comprising output data based on functional areas within a building, said output data being displayed to the user in at least one report.

10. The computer-implemented system of claim 1 wherein at least one of the databases is linked to a source of data wherein values in the data are periodically updated automatically.

11. The computer-implemented system of claim 1 wherein multiple building outcomes are computed based on different program, scope, attributes, and performance standards in the input data, and then compared and analyzed one to another to determine an optimal combination of such program, scope, attribute and performance standards.
